(19) United States
(12) Patent Application Publication
(10) Pub. No.: US 2008/0260134 A1
(43) Pub. Date: Oct. 23, 2008

(54) Apparatus, Method, And Computer Program Product For Outputting Audio Data During A Communication

(75) Inventor: Pertti Tolonen, Vantaa (FI)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation

(21) Appl. No.: 11/737,538

(22) Filed: Apr. 19, 2007

(51) Int. Cl. H04M 3/42

(52) U.S. Cl. 379/207.16

(57) ABSTRACT

A method for outputting audio data during a communication is provided. The method involves initiating an at least bilateral communications state, such as a bilateral audio communications state, between a first communications device and a second communications device. A pre-defined audio composition, such as a song, is caused to emanate at least temporarily during the bilateral communications state and substantially contemporaneously from each of the first and second communications devices. Corresponding apparatus and computer program products are also provided according to other aspects.

### FIELD OF THE INVENTION

Embodiments of the present invention relate generally to an apparatus, a method, and a computer program product for outputting audio data during a communication, and, more particularly, to an apparatus, a method, and a computer program product for causing a pre-defined audio composition to emanate at least temporarily during an at least bilateral communications state and substantially contemporaneously from each of first and second communications devices involved in the at least bilateral communications state.

### BACKGROUND INFORMATION

“Ring tone” refers to the sound made by a telephone to provide notification of an incoming call. Traditionally, ring tones utilized in standard telephones have consisted of standard sounds, such as buzzing or ringing. However, with the more recent advent and expanding use of cellular telephones and other mobile terminals, it has become common to customize the ring tone or ring tones associated with a given mobile terminal. This practice has grown to the point where the sale of ring tone data and software has become a significant business. However, while a personalized ring tone tends to provide enjoyment for the user of a mobile terminal associated with the personalized ring tone, this enjoyment does not extend to others that may communicate with the user. That is, callers to a mobile terminal having a personalized ring tone have no way to hear the personalized ring tone associated with their call.

### BRIEF SUMMARY OF THE INVENTION

In light of the foregoing background, provided are improved apparatuses, methods, and computer program products for providing output of a predefined audio composition during an at least bilateral communications state between at least two communications devices, such as during a voice call. The output is provided substantially contemporaneously at each communications device. By providing the output to the communications devices substantially contemporaneously, respective users of the communications devices may together experience the audio composition.

In one aspect, a method is provided that involves initiating an at least bilateral communications state, such as an at least bilateral audio communications state, between a first communications device and a second communications device. A pre-defined audio composition is caused to emanate at least temporarily during the bilateral communications state and substantially contemporaneously from each of the first and second communications devices. The audio composition may be selected from the group consisting of a song, a voice, a commercial recording, a user-generated series of musical notes, and a user-compiled series of sounds. Further, the audio composition may be caused to sound at a volume that is reduced when compared to a standard volume, and/or at a volume that reduces over a time that may be selectable via the first communications device.

In one embodiment, the first communications device may receive a request from the second communications device to initiate the bilateral communications state. In response to receiving the request, the audio composition may sound at the first communications device as an audible call notification. The bilateral communications state may then be initiated in response to the request. An identity associated with the second communications device may be detected, and the audio composition may be selected from a plurality of available audio compositions based on the identity associated with the second communications device.

In another aspect, an apparatus is provided that includes an input unit configured to accept data. A communications unit communicates with the input unit and is configured to send and receive data. As such, the communications unit may thereby support an at least bilateral communications state between the apparatus and a separate communications device. The apparatus also includes an audio output unit and a processing unit. The processing unit communicates with the communications unit and the audio output unit. The processing unit is configured to cause the audio output unit to output a pre-defined audio composition at least temporarily during the bilateral communications state, as well as to cause the communications unit to substantially contemporaneously send the audio composition to the separate communications device.

In yet another aspect, a computer program product is provided that includes a computer-readable storage medium having computer-readable program code portions stored therein. The computer-readable program code portions include a first and a second executable code portion. The first executable code portion initiates an at least bilateral communications state between a first communications device and a second communications device. The second executable code portion causes a pre-defined audio composition to emanate substantially contemporaneously from each of the first and second communications devices at least temporarily during the bilateral communications state.

In still another aspect, an apparatus is provided that includes input means for accepting data. Communications means communicate with the input means, the communications means sending and receiving data and thereby supporting an at least bilateral communications state between the apparatus and a separate communications device. Audio output means for outputting at least some of the data received by the communications means are also included. Processing means communicate with the communications means and the audio output means, the processing means causing the audio output means to output a pre-defined audio composition at least temporarily during the bilateral communications state. The processing means also cause the communications means to substantially contemporaneously send the audio composition to the separate communications device.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1A is a schematic illustration of a communications system including a communications device configured in accordance with an exemplary embodiment;

FIG. 1B is a block diagram representation of the communications device of FIG. 1A; and

FIG. 2 is a flow chart representing an exemplary method of communication.

### DETAILED DESCRIPTION OF THE INVENTION

The present inventions now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

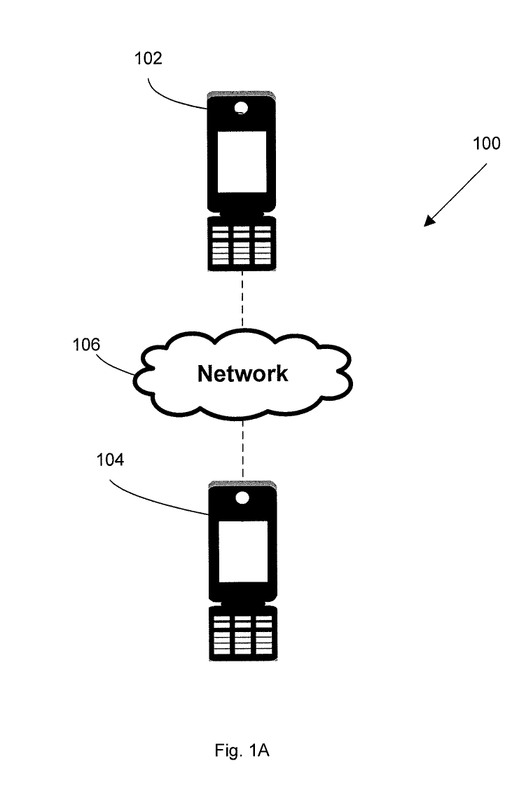

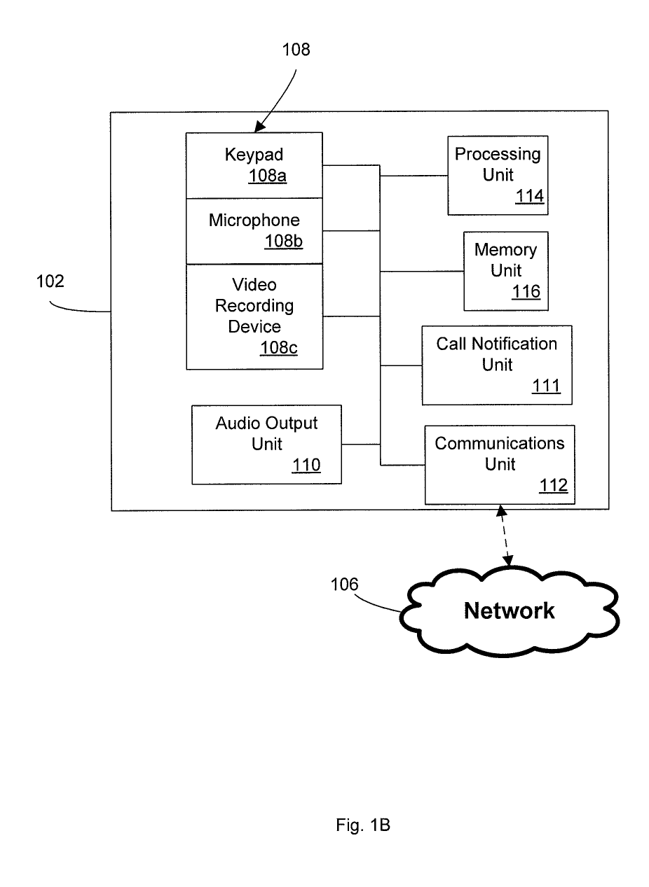

Referring to FIG. 1A, therein is shown a communications system 100 configured in accordance with an exemplary embodiment. Communications system 100 includes a first communications device 102, which is configured in accordance with an exemplary embodiment, and a second communications device 104, which may or may not be configured in accordance with an exemplary embodiment. Each of first and second communications devices 102, 104 may be any communications device, including, for example, a mobile terminal (e.g., a cellular telephone, a personal digital assistant (PDA), or a mobile computer), a stationary telephone (e.g., a wireline or landline telephone), or a desktop computer or other workstation. As described in more detail below, first and second communications devices 102, 104 may be configured to communicate, for example, via a network 106. The network can similarly be of any of a number of different types of networks, such as wireless or cellular networks, wireline networks, etc.

Referring to FIG. 1B, therein is shown a block diagram representation of communications device 102. Communications device 102 may include input means, such as an input unit 108, configured to accept data. Input unit may include, for example, a keypad 108a, a keyboard, a microphone 108b, and/or a video recording device 108c. Using input unit 108, data may be entered into communications device 102 by a user of the device. Communications device 102 may also include audio output means, such as an audio output unit 110, and a call notification unit 111. Both audio output unit 110 and call notification unit 111 may be, for example, an audio speaker, an earpiece, a hands-free listening device, or another component configured to output audio data. In some embodiments, audio output unit 110 and call notification unit 111 may be integrated into a single device, while in other embodiments, these components may be somewhat distinct.

Communications device 102 may further include communications means, such as a communications unit 112, configured to send and receive data. For example, communications unit 112 may include a transceiver and/or a network connection, such as a wireless network connection, a wide area network connection, a local area network connection, and/or an Internet connection. Communications unit 112 may thereby support a bilateral communications state between communications device 102 and a separate communications device, such as communications device 104 (FIG. 1A). In some embodiments, more than two communications devices may be involved in a communication, and communications unit 112 may thereby support a multilateral communications state between communications device 102 and several separate communications devices.

Communications unit 112 may be in communication with input unit 108 and audio output unit 110, such that communications unit 112 may receive at least some data via the network to be outputted by audio output unit 110 and may send data via the network that has been accepted by or entered with input unit 108. Communications unit 112, so configured, may therefore support a bilateral communications state consisting of an ongoing voice call between, say, two cellular telephones. However, communications device 102 may include any of a variety of output components, including a display, such that the bilateral communications state may involve the exchange of any of a variety of data forms, including audio data, video data, and/or textual data.

Processing means, such as a processing unit 114, may communicate with input unit 108, audio output unit 110, and communications unit 112. Processing unit 114 may be, for example, a programmable microprocessor, a digital signal processor, integrated circuitry including, for example, an application specific integrated circuit (ASIC), firmware, or some combination thereof. Processing unit 114 may be configured to cause audio output unit 110 to output a pre-defined audio composition at least temporarily during a bilateral communications state and to cause communications unit 112 to substantially contemporaneously send the same audio composition to a separate communications device, such as communications device 104 (FIG. 1A). Here, the phrase “substantially contemporaneously” is taken to mean simultaneously or only slightly offset temporally, such as due to the time delay incurred during transmission between communication devices. Communications device 102 may include a memory unit 116, such as, for example, a read-only memory (ROM), a programmable ROM (PROM), a random access memory (RAM), a dynamic RAM (DRAM), etc. that stores one or more pre-defined audio compositions. Memory unit 116 may also store instructions executable by processing unit 114 in performing the above described functions.

In some embodiments, processing unit 114 may cause the audio composition to be outputted and sent automatically, while in other embodiments, processing unit 114 may require receipt of a signal prompting the output and transmission of the audio output (e.g., depression of a designated key (not shown) on communications device 102). In some embodiments, processing unit 114 may prompt a user to consider providing manual authorization for the audio output. In still other embodiments, processing unit 114 may not be configured to cause communications unit 112 to send the audio composition to a separate communications device, but instead may transmit an indication of the audio composition to be outputted at the separate communications device. The audio composition may then be retrieved by the separate communications device, possibly from a memory of the separate communications device or from another source in the network. Alternatively, processing unit 114 may cause communications unit 112 to transmit an indication of the audio composition to a server that subsequently provides the audio communication to the separate communications device.

A pre-defined audio composition is any sound or group of sounds that is stored by the communications unit 112 or elsewhere for subsequent use. Possible examples of pre-defined audio compositions include a song, a voice, a commercial recording, a user-generated series of musical notes, a user-compiled series of sounds, and the like. Generally, there is no limit on what may be used as an audio composition.

In one embodiment, the bilateral communications state may be an ongoing phone call between communications device 102 and a separate communications device 104. Processing unit 114 may cause audio output unit 110 to output, say, a song that is heard in parallel with the conversation associated with the ongoing phone call. Processing unit 114 may also cause communications unit 112 to send the same song to separate communications device 104 for output in parallel with the audio conversation of the ongoing phone call. The song may be outputted substantially contemporaneously at communications devices 102 and 104, such that users at both ends may experience the song together and in unison. The song may be outputted at a volume that is reduced when compared to a standard volume. The standard volume may be chosen to be the volume of a typical conversation or the volume at which most persons prefer to hear conversations, thereby allowing the song to be heard in the background of an ongoing conversation between users of communications devices 102, 104 without hindering the conversation.

Processing unit 114 may be configured to detect requests from separate communications devices for the initiation of bilateral communications. In response to such detected requests, processing unit 114 may prompt the output an audio composition as a notification of the request. As an example, processing unit 114 may detect an incoming phone call being received by communications unit 112 from communications device 104 (FIG. 1A). In response to detecting the request, processing unit 114 may cause call notification unit 111 to output an audio composition as an audible call notification, that is, as a “ring tone.” If the call is answered, either the same or a different audio composition as that which is provided as the audible call notification could then be played simultaneously in the background of any ensuing conversation for both the caller, via audio output unit 110, and the call recipient. Processing unit 114 may also detect an identity associated with the separate communications device 104, possibly using data received via communications unit 112. The identity may relate to device 104 or may be input by a user of device 104. Processing unit 114 may then choose the audio composition and/or the audible call notification from a plurality of available audio compositions (e.g., from an audio composition library) based on the identity. This would allow a user of communications device 102 to quickly identify the caller associated with an incoming call.

Processing unit 114 may control the output of the audio composition in a variety of ways. For example, processing unit 114 may cause the volume of the audio composition to reduce over time, say, such that the audio composition “fades out.” The time over which the audio composition volume is reduced may be user-selectable. Alternatively, the audio composition may be caused to play until completion, may be caused to play until a user-specified indication of termination is received (e.g., via user input 108), or may be caused to play continuously throughout a state of bilateral communications such as an ongoing phone call.

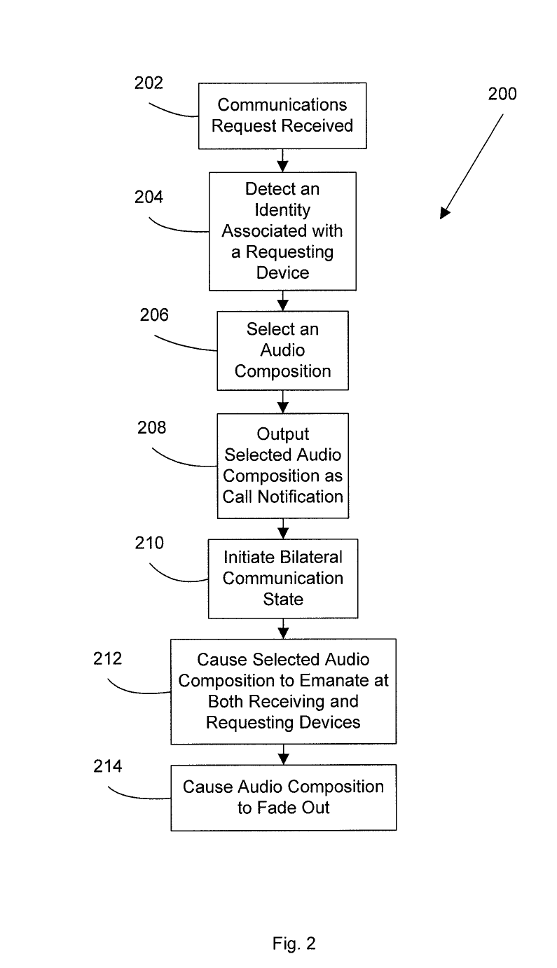

Referring to FIG. 2, therein is shown a flow chart representing an exemplary method 200 of communicating using, for example, a communications device, in this case a cellular telephone, configured as described above. Method 200, as described herein, involves audio communications between two cellular telephones. However, it should be understood that the described method can easily be adapted for other types of communication, including, for example, video conferencing and instant messaging, and for communication between other types of communications devices, such as personal computers, PDAs, pagers, stationary telephones, and the like.

At Block 202, a first cellular telephone may receive a request from a second cellular telephone to initiate a bilateral communications state, in this case a phone call. At Block 204, an identity associated with the second (requesting) cellular telephone may be detected. For example, the second cellular telephone may transmit, perhaps in conjunction with the call request, a unique identification number that may be extracted from the call request. At Block 206, an audio composition, such as a song, is selected, perhaps from a library of available songs, based on the identity associated with the second cellular telephone. For example, each potential caller or calling device may be associated with a unique song from a song library.

At Block 208, the selected song can be audibly outputted as a notification of the call or as a “ring tone.” This notification signals to a user of the first (receiving) cellular telephone that a call is available to be answered. At Block 210, a bilateral communications state may be initiated by answering the incoming call. Once the bilateral communication state has been initiated, at Block 212 the selected song can be caused, perhaps automatically, to emanate substantially contemporaneously from each of the first (receiving) and second (requesting) cellular telephones. As such, the song may be audibly outputted in parallel with the audio of the phone conversation, for all parties to the conversation to hear. The audio output of the song following call initiation may be at a volume that is less than the volume of call notification, and may be at a volume that is lower than a standard volume, such as the volume for a typical conversation. The song may sound temporarily during the conversation, or may play continuously throughout the conversation. In cases where the song is temporarily played, at Block 214 the song can be caused to fade out by reducing the volume of the song to zero, thereby leaving only the conversation.

As described above and as will be appreciated by one skilled in the art, embodiments of the present invention may be configured as a system, an apparatus, or a method. Accordingly, embodiments of the present invention may be comprised of various means including entirely of hardware, entirely of software, or any combination of hardware and software. Furthermore, embodiments of the present invention may take the form of a computer program product on a computer-readable storage medium having computer-readable program instructions (e.g., computer software) embodied in the storage medium. Any suitable computer-readable storage medium may be utilized including hard disks, CD-ROMs, optical storage devices, or magnetic storage devices.

Exemplary embodiments of the present invention have been described above with reference to block diagrams and flowchart illustrations of methods, apparatuses (i.e., systems) and computer program products. It will be understood that each block of the block diagrams and flowchart illustrations, and combinations of blocks in the block diagrams and flowchart illustrations, respectively, can be implemented by various means including computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A method comprising:
initiating an at least bilateral communications state between a first communications device and a second communications device; and
causing a pre-defined audio composition to emanate substantially contemporaneously from each of the first and second communications devices at least temporarily during the at least bilateral communications state.

2. A method according to claim 1, further comprising receiving at the first communications device a request from the second communications device to initiate the at least bilateral communications state, and wherein said initiating the at least bilateral communications state includes initiating the at least bilateral communications state in response to receiving at the first communications device the request to initiate the at least bilateral communications state.

3. A method according to claim 2, further comprising causing the audio composition to sound at the first communications device as an audible call notification in response to receiving at the first communications device the request to initiate the at least bilateral communications state.

4. A method according to claim 1, wherein the audio composition is selected from the group consisting of a song, a voice, a commercial recording, a user-generated series of musical notes, and a user-compiled series of sounds.

5. A method according to claim 1, wherein said initiating the at least bilateral communications state includes initiating an at least bilateral audio communications state, and wherein said causing the audio composition to sound simultaneously at each of the first and second communications devices includes causing the audio composition to sound at a volume that is reduced when compared to a standard volume.

6. A method according to claim 1, wherein said causing an audio composition to sound simultaneously at each of the first and second communications devices includes causing the audio composition to sound at a volume that reduces over time.

7. A method according to claim 6, wherein the time over which the volume of the audio composition reduces is selectable via the first communications device.

8. A method according to claim 1, further comprising detecting an identity associated with the second communications device and selecting the audio composition from a plurality of available audio compositions based on the identity associated with the second communications device.

9. An apparatus comprising:
an input unit configured to accept data;
a communications unit in communication with said input unit and configured to send and receive data and thereby support an at least bilateral communications state between said apparatus and a separate communications device;
an audio output unit; and
a processing unit in communication with said communications unit and said audio output unit and configured to cause said audio output unit to output a pre-defined audio composition at least temporarily during the at least bilateral communications state and to cause said communications unit to substantially contemporaneously send the audio composition to the separate communications device.

10. An apparatus according to claim 9, further comprising a call notification unit in communication with said processing unit, and wherein said processing unit is further configured to detect a request from the separate communications device for initiation of the at least bilateral communications state and to cause said call notification unit to output the audio composition as an audible call notification in response to detecting the request.

11. An apparatus according to claim 10, wherein said call notification unit is integral with said audio output unit.

12. An apparatus according to claim 9, wherein the audio composition is selected from the group consisting of a song, a voice, a commercial recording, a user-generated series of musical notes, and a user-compiled series of sounds.

13. An apparatus according to claim 9, wherein said input unit is configured to accept audio data, wherein said communications unit is configured to send and receive audio data, wherein said audio output unit is configured to output at least some of the data received by said communications unit, and wherein said processing unit is configured to cause said audio output unit to output the audio composition at a volume that is reduced when compared to a standard volume and is further configured to cause said communications unit to send the audio composition to the separate communications device with the volume that is reduced compared to the standard volume.

14. An apparatus according to claim 9, wherein said processing unit is configured to cause said audio output unit to output the audio composition at a volume that reduces over a user-selectable time and to cause said communications unit to send the audio composition to the separate communications device at a volume that reduces over the user-selectable time.

15. An apparatus according to claim 9, wherein said communications unit is configured to receive an identity associated with the separate communications device and said processing unit is configured to select the audio composition from a plurality of available audio compositions based on the identity associated with the separate communications device.

16. An apparatus according to claim 9, further comprising a memory unit in communication with said processing unit and configured to store at least one audio composition.

17. An apparatus according to claim 16, wherein said memory unit is further configured to store instructions executable by said processing unit to cause said audio output unit to output an audio composition at least temporarily during the at least bilateral communications state and causing said communications unit to substantially contemporaneously send the audio composition to the separate communications device.

18. An apparatus according to claim 9, wherein said apparatus is incorporated as part of a mobile terminal.

19. A computer program product comprising a computer-readable storage medium having computer-readable program code portions stored therein, the computer-readable program code portions comprising:
a first executable code portion for initiating an at least bilateral communications state between a first communications device and a second communications device; and
a second executable code portion for causing a pre-defined audio composition to emanate substantially contemporaneously from each of the first and second communications devices at least temporarily during the at least bilateral communications state.

20. An apparatus comprising:
input means for accepting data;
communications means in communication with said input means for sending and receiving data and thereby supporting an at least bilateral communications state between said apparatus and a separate communications device;
audio output means for outputting at least some of the data received by said communications means; and
processing means in communication with said communications means and said audio output means for causing said audio output means to output a pre-defined audio composition at least temporarily during the at least bilateral communications state and for causing said communications means to substantially contemporaneously send the audio composition to the separate communications device.
